(19) United States
(12) Patent Application Publication
(10) Pub. No.: US 2012/0042322 A1
(43) Pub. Date: Feb. 16, 2012

(54) Hybrid Program Balancing

(75) Inventors: Ake Arvidsson, Solna (SE); Per Anders Holmberg, Stockholm (SE)

(73) Assignee: Telefonaktiebolaget L M Ericsson (publ.), Stockholm (SE)

(21) Appl. No.: 13/148,308

(22) PCT Filed: Feb. 4, 2009
(86) PCT No.: PCT/IB2009/005084

§ 371 Date: Aug. 5, 2011

(30) Foreign Application Priority Data
Mar. 9, 2009 (EP) 09154608.5

(51) Int. Cl. G06F 9/46

(52) U.S. Cl. 718/105

(57) ABSTRACT

A method for balancing loads in a system having multiple processing elements (800) includes executing a plurality of load balancing algorithms in a dry run on load data from the system (810, 820, 830, 840), recording the results of each of the load balancing algorithms (815, 825, 835, 845), evaluating the results of each of the load balancing algorithms (850), selecting a load balancing algorithm providing the best results (855) and implementing the results of the selected algorithm on the system (860).

### TECHNICAL FIELD

The present invention relates to load balancing and more particularly to methods for optimizing load balancing between multiple processing resources such as by distributing programs or program modules.

### BACKGROUND

Processing resources can include nodes, chips, cores, threads, etc. The distribution of programs (or program modules) among multiple processing resources to obtain an even distribution of the load is highly desirable. An even distribution of the load (programs or program modules) leads to a reduction in the response times and lowers the risk of rejection of service requests by programs due to lack of processing resources.

Load balancing is desirable in many arrangements such as, for example, in: (1) virtual machines that include or utilize multiprocessors and multi-core processors; (2) embedded applications; and (3) a cluster interconnect (of processors or processing elements). A common method of implementing a cluster interconnect is by using a LAN (local area network) for example.

Multiple algorithms are known for balancing loads in multiprocessor systems. Operating systems, such as Linux, implement different versions of dynamic load balancing in which the system rebalances continuously in order to adapt to variable and unpredictable loads. A majority of these algorithms typically provide improved performance under certain conditions but insignificant improvements under other conditions. A majority of these algorithms also typically provide an improvement with a few actions under certain conditions but with many actions under other conditions. That is, the algorithms differ not only by gain but also by cost. The algorithms are developed based on assumptions regarding the load and requirements pertaining to the number of moves, acceptable lack of balance, etc. These assumptions are not always valid and a prior knowledge of the assumptions does not always exist. In some instances, the assumptions may have been simplified and do not reflect the actual need.

If achieving a best possible result (such as by using a minmax criterion for example in which the load on the highest loaded unit is minimized) within K (where K may be determined by time or cost) program migrations is desired, this can be accomplished by algorithms that obtain large improvements with few, but not guaranteed, number of moves. Another alternative may be to incorporate “greedy” algorithms which make the most important move first and can be cut (i.e. ending or aborting the process) after K moves. The concept of “best” in this context may be a combination of maximum gain and minimum cost. Gain may be measured as an improvement in the balance which is reflected by a reduction in the load on the most loaded processor. Cost may be measured as the number of modules that are moved.

The first type of algorithm (i.e. those obtaining improvements with few, unguaranteed moves) may be very efficient, but without guarantees. It may end up with a useless result, either not finding any moves or finding too high a number (more than K). The second type of algorithm (i.e. “greedy”) may be less efficient but achieves a useful balance within the prescribed limit.

Most operating systems implement different versions of dynamic load balancing that work well over a wide range of application characteristics.

Load Balancing may include program balancing and traffic balancing. Program balancing is the balancing of programs onto the processing units of a processor (i.e. onto the processor cores of a multi-core processor and/or hardware threads of a multithreaded processor). Traffic balancing is the balancing of traffic, calls or message streams onto programs and program instances. Multiprocessors support allows for multiple instances of the same program on one processor to create more concurrency. Program Instances are independent programs when they execute (e.g., they can be started, stopped etc. independently and they can execute on separate processing units) but share code and software management (such as upgrade for example). Program migration is the moving of a program (or a program instance) from one processing unit to another processing unit when executing on a multi-core and/or multithreaded processor.

Program balancing is directed to achieving as good a balancing as possible (via the minmax criterion for example) by migrating programs between cores in a multi-core processor (or between processors in a multiprocessor). Program balancing can be accomplished either statically by configuring program placement on cores or it can be done automatically (i.e. dynamically) during operation based on measured program loads.

Some operating systems, such as the OSE5-MP operating system for example, support rebalancing of programs by providing for the measuring of the load of each program instance and for the moving of program instances from one core to another core.

Program balancing in an OSE5-MP is intended to be achieved by creating a separate load balancer program that periodically reads program loads, runs a load balancing algorithm and moves one or more program instances to improve the balance. A sample load balancer is typically provided with the OSE5-MP. However, users are expected to design their own load balancer for replacing the sample load balancer.

The OSE operating system does not support the type of load balancing that is available in standard operating systems such as Unix and Linux where the load balancing is performed as part of scheduling programs or processes (i.e. as part of the context switch). The same program can be scheduled on multiple processing elements wherever there is free capacity. A processor (processor referring here to a system with multiple processing units) with dynamic load balancing can typically accept a higher load in a soft real time system.

The sharing of load between cores can lead to an increased level of cache misses. However, on multi-core processors, these misses are on-chip cache-cache transfers giving a small overhead and most “soft real time” applications perform better on systems with dynamic load balancing.

Existing algorithms for program balancing are based on heuristics. The algorithms, therefore, cannot guarantee an optimal result but can sometimes guarantee that the result is within an acceptable limit from the optimal result.

The application software can help program balancing by over-providing parallelism. An access to more programs makes it simpler for the program balancer to fill out smaller gaps to balance the load. However, having too many programs leads to an increase in memory usage and scheduling overhead which might affect execution performance.

Due partly to larger cache sizes and shared caches in modern processors, the over-provisioning of parallelism is less of a problem in multiprocessor systems.

As a practical matter, a big variation in program load may occur. A few programs may generate almost all the load and many programs may generate low or no load. Therefore, moving of some programs may not make any difference and this situation needs to be avoided.

Some operating systems, such as the OSE operating system allows for migrating programs between cores one program at a time. However, there is no mechanism for exchanging two programs (at a time) between cores or for migrating multiple programs (at a time) as this could lead to an error condition if one of the programs being exchanged or migrating terminates or crashes.

The moving of a program between processor cores may require synchronizations of the processor cores (that is, sending an interrupt and stop all cores to make sure that the program is not currently executing). The overhead for sending an interrupt is at least an order of magnitude larger than the operation needed to do the actual program migration. If multiple programs are not allowed to be migrated at one time, this overhead is repeated for each program that is to be migrated.

If the amount of time needed for migration is known, it can be assumed that K migrations can take place within a scheduling interval. Based on knowledge or estimation of execution time for one migration, an upper bound on the overhead for program migrations can be achieved by setting a limit on the number of migrations. An algorithm can then be developed for providing the best possible result within K migrations.

If an algorithm results in many migrations, then the algorithm may have to provide for distributing the migrations over time. A few of the migrations may take place first, some traffic execution may take place next followed by more migrations and repeating this process for example. However, if the algorithm swaps or exchanges some programs between cores and is forced to idle in the middle (i.e. migration is temporarily aborted in order to allow other programs to execute), then the system will be in an unbalanced state for a short time (corresponding to the time that it is idle). Some algorithms are “greedy” in that they attempt to obtain the best improvement in every step. This means that it is possible to pick the first K migrations from a list of migrations. Also, it is possible to divide migrations into batches which may be interleaved by breaks. The balance will then improve for each batch.

The performance of a balancing algorithm is measured on how well the algorithm performs on the highest loaded processor core. For a given program workload, there is an optimal balance that can be achieved with a minimum load value on the highest loaded core. The performance of the algorithm may be indicated by the difference on the highest loaded processor core (|A−B| in FIG. 1) between the actual load balance and the optimal load balance. Since a true optimum B is typically unknown, the optimum using the exemplary minmax criterion occurs when the highest loaded core is minimized.

FIG. 1 illustrates four cores, P0 to P3 with an actual processor load balance and an optimal load balance for each core. Algorithm performance may also be measured by computing the value of A/B (i.e. with A>B or B>A).

Current processors can decrease clock speed and voltage in order to save energy. A good load balance also gives the processor the opportunity to decrease the power consumption. A low energy consumption is obtained with a good load balance at the load levels where the processor spends most of the time (and not only at peak load).

### SUMMARY

In one embodiment, a method for balancing loads in a system comprising multiple processing elements is disclosed. The method comprises: executing a plurality of load balancing algorithms in a dry run on load data from the system; recording the results of each of the load balancing algorithms; evaluating the results of each of the load balancing algorithms; selecting a load balancing algorithm providing the best results; and Implementing the results of the selected algorithm on the system.

### BRIEF DESCRIPTION OF THE DRAWINGS

The various features, advantages, and objects of this invention will be understood by reading this description in conjunction with the drawings, in which:

FIG. 1 illustrates actual load balance and optimal load balance on a quad core processor;

FIG. 2 illustrates a load profile on a quad core processor without load balancing;

FIGS. 3A-3D illustrate load balancing of a quad core processor using the distribution algorithm;

FIGS. 4A-4D illustrate load balancing of a quad core processor using the move big job algorithm;

FIGS. 5A-5D illustrate load balancing of a quad core processor using the greedy moves algorithm;

FIGS. 6A-6D illustrate load balancing of a quad core processor using the partitioning algorithm; and

FIGS. 7A-7D illustrate load balancing of a quad core processor with the hybrid algorithm according to exemplary embodiments; and

FIG. 8 illustrates a method according to exemplary embodiments.

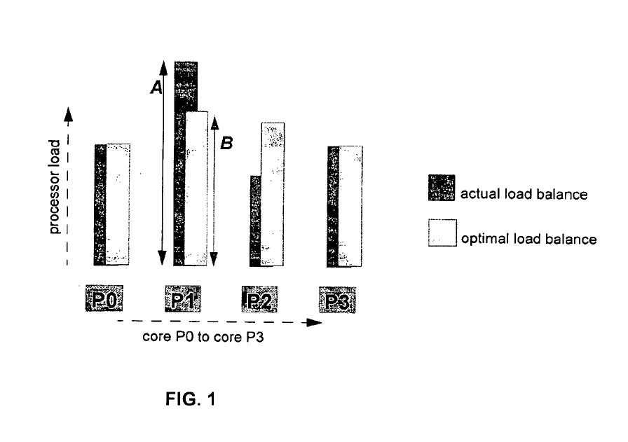

### DETAILED DESCRIPTION

The following description of the implementations consistent with the present invention refers to the accompanying drawings. The same reference numbers in different drawings identify the same or similar elements. The following detailed description does not limit the invention. Instead, the scope of the invention is defined by the appended claims.

A load balancing algorithm is typically a series of steps for computing a feasible approximation of balanced loads. The output or result of a load balancing algorithm is a placement list (of programs). The list may specify that a particular program should be run on a particular processor and another particular program should be run on another particular processor (e.g. program A should run on processor X, program B should run on processor Y, etc.). Different load balancing programs (such as those described in further detail below) may end up with different placement lists. No particular algorithm always specifies the “best” placement list or “best” balancing—that is, one algorithm may be “best” for a particular situation and another algorithm may be the “best” for another situation. Known load balancing solutions select one algorithm which is always used.

In general, exemplary embodiments evaluate load balancing on a system comprising a plurality of processing elements by executing “dry runs” of a plurality of load balancing algorithms on load data from the system and implementing the result (e.g. placement list) of the algorithm providing the best result (i.e. an approximation of the optimum result). Implementation in this context may refer to applying the placement list by assigning particular programs to particular processors or processing elements as specified by the placement list. Load data for the dry run may be collected by a monitoring function which typically is part of an operating system in one of the processing elements and such data may be collected from operating systems associated with several processing elements.

The term “dry run” refers to the fact that the evaluation is performed in a simulated environment rather than in the real system. The simulated environment represents all software modules as data objects with assigned current (real) loads and current (real) processors. Load balancing algorithms may be applied to these objects. Results from algorithms can be compared with each other and the algorithm with the “best” results can be selected. Results of the selected algorithm can then be implemented to the real system.

In preferred embodiments, algorithms may be developed to improve the load balance with every move and to obtain the best possible balance within K moves (K can be predetermined or specified). Other criteria may include reducing power consumption.

Some programs such as, interrupt routines for example, can be locked to cores. In exemplary embodiments, the algorithm provides a scheduling that takes this fact into consideration by reducing the capacity of these cores by the load produced by the locked programs for example. When there is one program which generates most of the load, a bad balance results. In exemplary embodiments, an algorithm moves this program from the core with the locked programs.

In exemplary embodiments, the selection of algorithm may be based on best improvement within K moves.

The exemplary algorithms were simulated using two different data sets on both dual and quad core processors. The exemplary data sets consist of load numbers for the programs each time the scheduling algorithm is invoked. The exemplary data sets consist of load numbers that change in larger steps than likely to be encountered in typical operating conditions. The exemplary data sets were created under two scenarios: (1) limited parallelism with a dominating program; and (2) multiple, load shared programs. Under the first scenario, the software has not been adopted to multi-core processors by load sharing. There is one program that uses the majority of the capacity and several other programs with smaller load. A few of the programs generating a smaller load are locked to core 0. The goal of this scenario is to migrate the dominating program from core 0 (the core with the locked programs) to another core.

Under the second scenario, the software has parallelism using load sharing and can be scaled to use many cores by using multiple program instances. The software may include two programs, X and Y that are instantiated with one instance per core (i.e. 2X+2Y for a dual core, 4X+4Y for a quad core processor). Program X uses more capacity than Y when starting at low load. At higher load, one of the Y programs dominates, pushing other programs from its core. A few smaller programs may be locked to core 0 in this case. The load balancing algorithms have been simulated using a standalone C program using input data sets.

Since the data sets have few programs and limited parallelism, the differences between the algorithms may be exaggerated. More parallelism provides more opportunities for the algorithms to achieve a good balance.

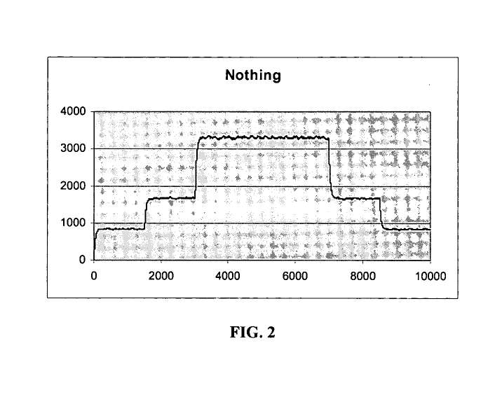

FIG. 2 illustrates the load profile without load balancing for an exemplary data set on a quad core processor when running all programs on a single processor core. All the programs remain on core 0. The load on the remaining cores remains at 0. In each of FIGS. 2 to 7D, the horizontal axis represents time and the vertical axis represents load.

In order to generate a hybrid algorithm according to exemplary embodiments, other (known) algorithms are briefly described below. These other algorithms are exemplary and described for illustrative purposes and are not exhaustive in nature. They are: the Distribution algorithm, the Move Big Job algorithm, the Greedy Moves algorithm and the Partitioning algorithm.

A set of desired characteristics for each of these algorithms may initially be established. These characteristics aim for: good load balancing for software that is not adjusted for a multi-core; good load balancing for software that is adjusted for a multi-core; not getting stuck in a less than optimal balance; and a low number of migrations. Additional characteristics may include not overloading the cores during migration and the ability to handle priorities.

The “Distribution” algorithm considers all programs on all cores and arranges them according to their load. Each program is assigned one at a time based on its load. The program with the highest load is assigned first and the program with the (next) highest load is assigned to the processor that is presently the lowest loaded processor and this process is repeated until all programs are assigned.

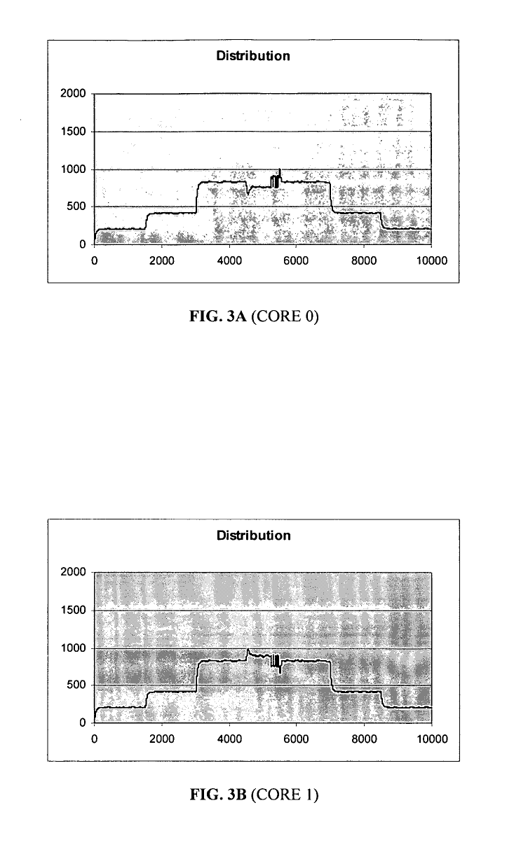

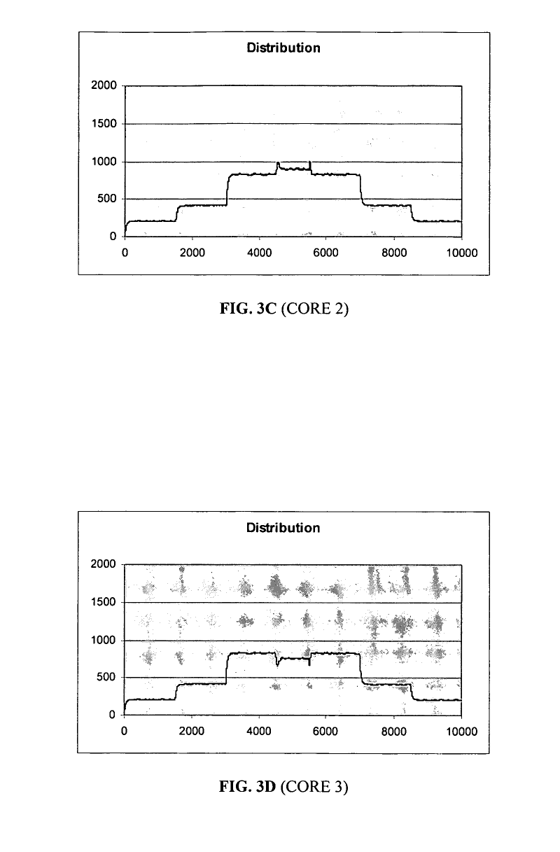

The distribution algorithm among four cores is illustrated in FIGS. 3A-3D. While the loads for each of the cores appear balanced, this load distribution is achieved at the cost of many program migrations.

The Distribution algorithm provides the best guaranteed upper bound for the highest loaded processor in an M processor system. That is, the algorithm can be shown never to load the most loaded processor more than a certain factor times the optimal solution. The highest load on a processor can not be more than (4/3)−(1/3*M) times the load on the highest loaded processor in optimal load balancing for example. In a dual core system (i.e. with M=2), the highest load cannot be more than 1.667*(times) the highest loaded processor in optimal load balancing. In a quad core system (with M=4), this factor is 1.25; in multi core system (where M is a very high number such as approaching an infinite value), this factor is 1.33.

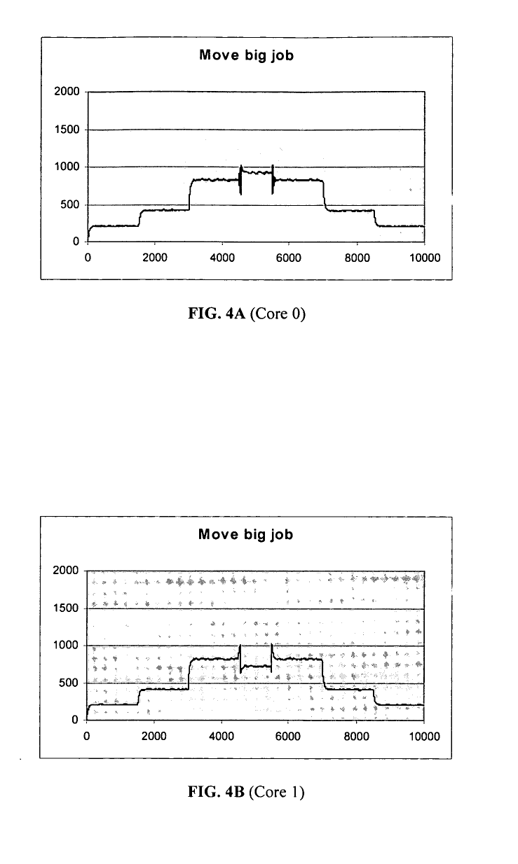

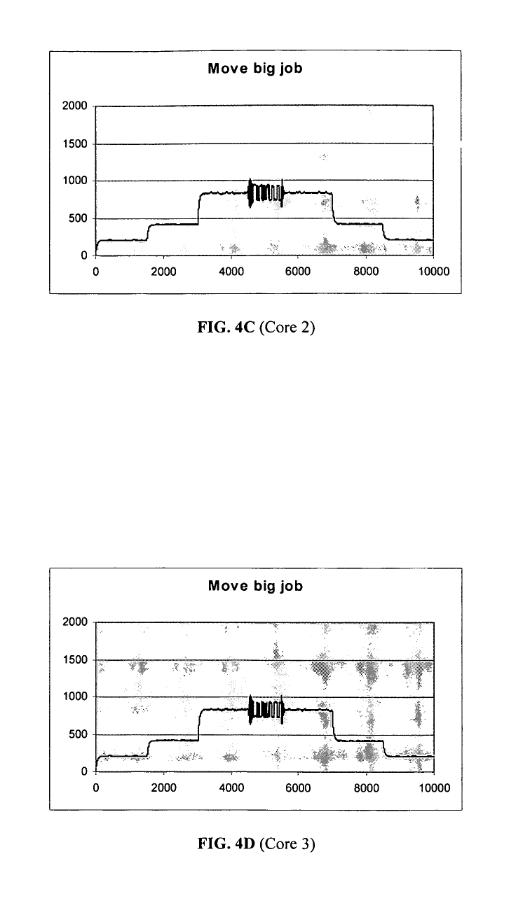

The Move Big Job algorithm is a variation of the Distribution algorithm that considers only the “big” programs. A “big” program may refer to how dominant the program may be in terms of load. For example, if nine programs or modules are responsible for 90% of the load and 90 programs are responsible for the other 10% of the load, then the nine programs may be considered to be “big” programs and the other ninety programs may be considered to be small (i.e. not “big”). In this example, a big program is one that takes up 10% of the load. Small programs may be excluded from redistribution since they will not make much difference for the total result (since adding or subtracting a fraction of a percent of load does not affect the balance but such operations will be as costly as if applied to the big jobs). The redistribution algorithm can be executed on fewer objects; this speeds up the computation time and the implementation time while correspondingly reducing the computation cost and the implementation cost. The value of 10% (for defining a big program) is purely arbitrary and this number could just as well be 5% or some other number for example. In the Move Big Job Algorithm (unlike in the Distribution algorithm), many small programs that do not really affect the final result are not moved around. FIGS. 4A-4D illustrate load balancing on each core of the four core processor with the Move Big Job algorithm.

The Greedy Moves algorithm may first select the highest loaded processor core. It then locates the lowest loaded core and attempts to move the most demanding program (from the highest loaded core to the lowest loaded core) to even out the load. After each successful move, the algorithm locates the currently lowest loaded core until no more moves are possible or needed. The concept of this algorithm is to focus on the problem (i.e. the highest loaded processor) and then get as large an improvement as possible in the next migration. This algorithm may continue until no more migrations are possible or it may be set to do just one migration or up to a fixed number of migrations (such as K migrations). This algorithm also guarantees an improvement even if it is stopped somewhere in the middle (prior to exhausting the K number of migrations).

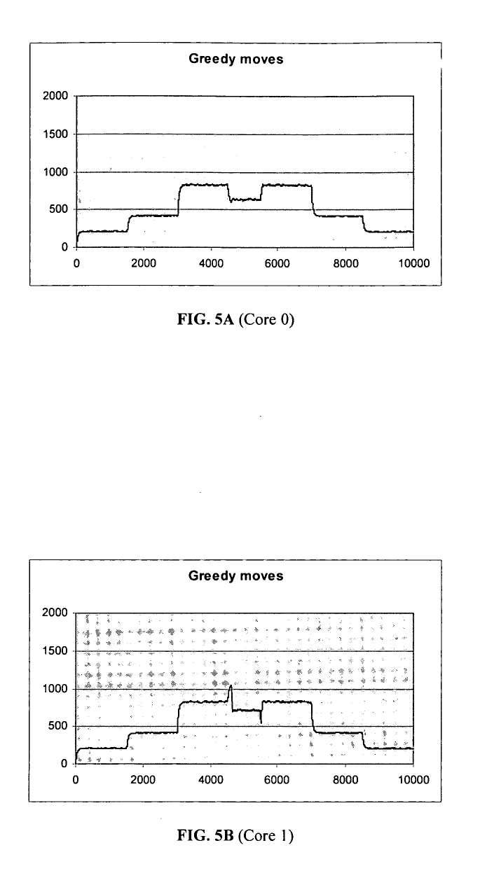

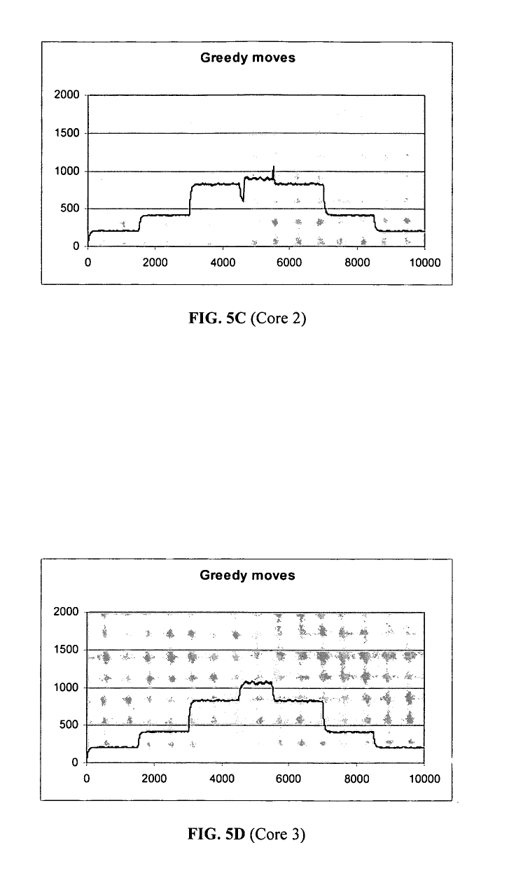

FIGS. 5A-5D illustrate load balancing associated with the Greedy Moves algorithm. As illustrated, the Greedy Moves algorithm also provides a good load balance although it doesn't find the optimal load balance in this exemplary embodiment.

The Partitioning algorithm is designed for rebalancing. This algorithm considers the current load situation and removes and reallocates the minimal number of programs to get a balance that is within a guaranteed limit which is almost as narrow as the one for the Distribution algorithm.

The Partitioning algorithm divides the programs into “large” and “small” categories using a heuristic. A large program is defined as one that (takes up a load which) is larger than one-half (½) of the optimal highest load on a processor. The number of large programs can be anywhere from 0 to M where M is the number of cores. The Partitioning algorithm first selects the programs that should be reallocated. These are the large programs (except for the smallest of them that are left on their cores) and a minimal number of small programs (“small” being anything that is not “large”). The selected programs are then removed and reassigned, one program at a time, to the processor that is currently the lowest loaded processor.

A guaranteed minimal number of program migrations, however, results in a slightly higher guaranteed upper bound for the load balance. The highest loaded processor core can at most be 1.5 times the optimal (compared to 1.33 for Distribution).

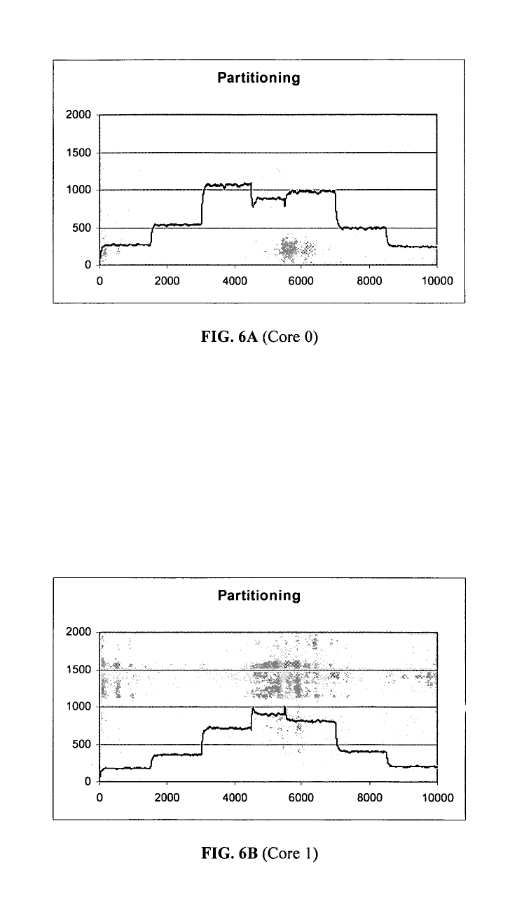

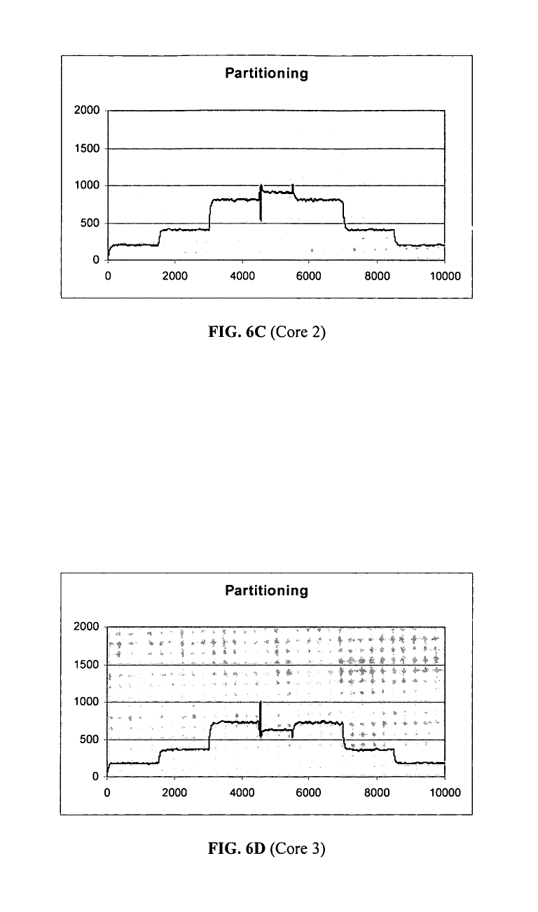

FIGS. 6A-6D illustrate load balancing using the partitioning on a quad core processor. As seen in this exemplary embodiment, the Partition algorithm performs a little bit worse than the Distribution algorithm. The highest loaded processor has a load that is slightly above 1000 during an interval compared to being slightly under or at the 1000 load value. Load values such as 1000 should be viewed as relative values.

The Partition algorithm does not handle data optimally in all cases since it assumes that all cores are equal. Partitioning also includes fewer migrations than the other algorithms.

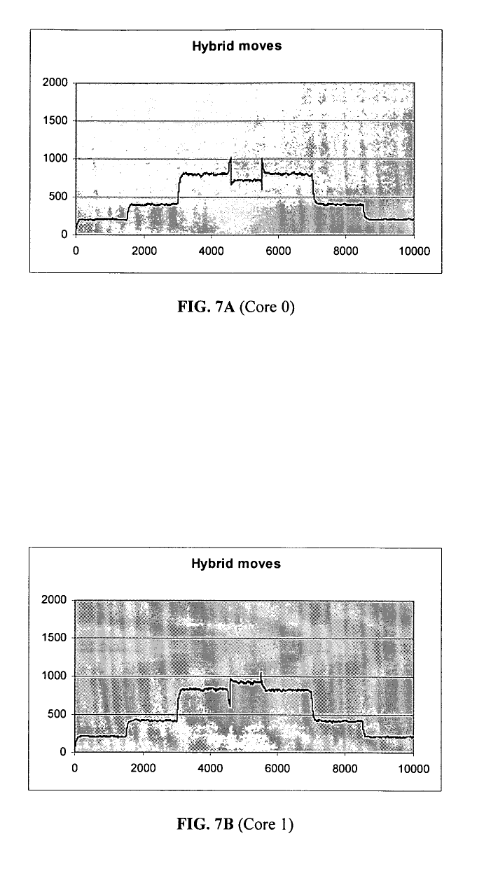

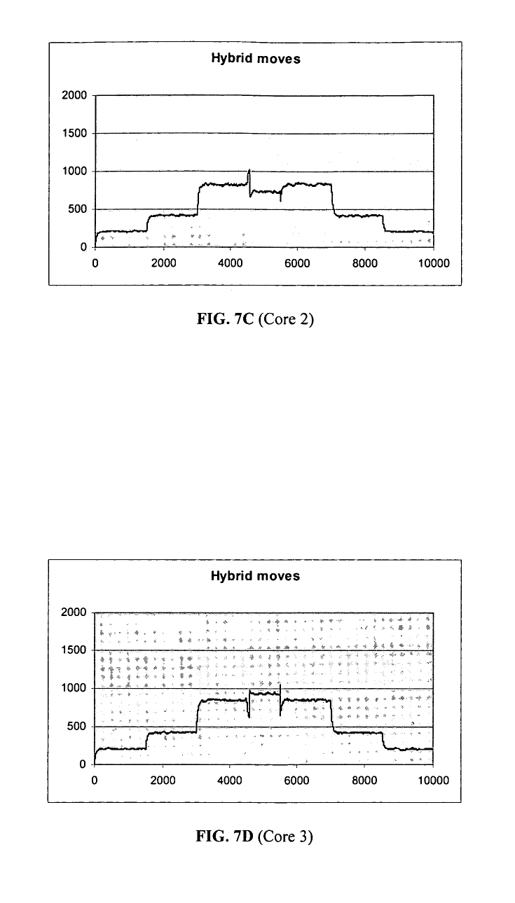

The Hybrid algorithm combines the algorithms described above to get a best value each time. There may also be a threshold for not implementing results of the hybrid algorithm. This may occur if the max load does not decrease by a predetermined amount (such by 5% for example). If this threshold is not achieved by any of the algorithms, then no balancing may take place. FIGS. 7A-7D illustrate the load balance resulting from implementing results of the hybrid algorithm.

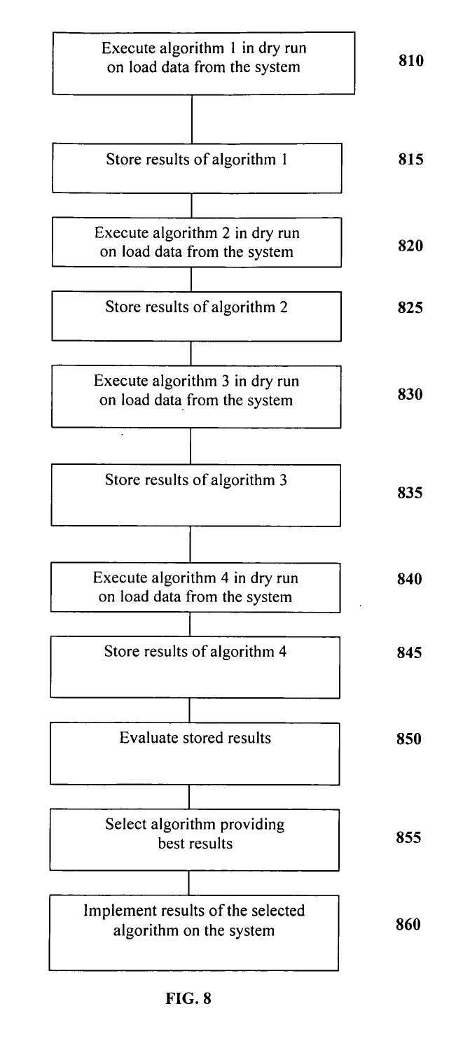

An exemplary method for implementing results of the hybrid algorithm is illustrated in FIGS. 8A-8D. Each of the (four in this illustrated example) exemplary algorithms are executed in a dry run on load data (810, 820, 830 and 840). The results of each of these algorithms are stored (815, 825, 835 and 845). The results of the algorithms are evaluated (850). The algorithm providing the best or optimum result (e.g. placement list) is selected (855).

In an exemplary embodiment, the best value may be defined as: (max load system−max load dry run)/number of moves. Max load system refers to the monitored load of the processing element having the highest load in the system and max load dry run refers to the calculated load of the processing element having the highest load in the dry run and the number of moves corresponds to the number of migrations necessary to implement placement list of the dry run. Results of the selected algorithm may be implemented on the system. (860).

The evaluation and implementation as described above according to exemplary embodiments may take place at a predetermined (or periodic) interval or on a continuous basis. In some embodiments, predictions on future loads may also be made (in advance) based on trends in progress like increasing or decreasing loads. Known predictors such as the Kalman filter may be used to make these predictions.

The Hybrid algorithm provides as good a load balance (if not a better load balance) with a low number of migrations than any of the other algorithms since the balance per move may be better. The hybrid algorithm may be further modified to introduce a maximum limit on the number of migrations by excluding dry run results that involve more than K migrations.

The hybrid approach as described in exemplary embodiments provides optimal, or near optimal, load balance. Furthermore, migrations are also minimized or reduced. Optimal load balancing is NP (non polynomial). Also, multiple heuristic algorithms may be implemented to avoid weak areas of individual heuristic algorithms. The hybrid approach gets closer to an optimum value than a single algorithm and at a lower cost.

As the load balancing improvement remains unchanged with different number of cores, methods according to exemplary embodiments may be scalable for future generations of multiple core systems.

The methods as described are not limited only to a multi-core processor but are also applicable to balancing programs on clusters and balancing of virtual machines on multi-processors and multi-core processors. The methods as described herein may be implemented within operating systems utilized in mobile communication networks.

Furthermore, while four exemplary algorithms are illustrated, this number could be greater or lesser than four. Also, one or more other algorithms may also be used in place of any one or more of the algorithms described. One or more other algorithms may also supplement (i.e. in addition to) the algorithms described.

Balance is evaluated between cores. Various algorithms are compared and the algorithm providing the best result (balance) may be viewed as approximating the optimum. Optimum implies the loads are as equal as possible. A deviation from the optimum may depend on the particular conditions and differs between different algorithms with no algorithm always being the best one.

In order to find an “optimum” algorithm, a combination of maximum gain and minimum cost may be used according to exemplary embodiments. Gain may be measured as an improvement in balance indicated by a reduction of the load on the most loaded processor. Cost may be measured as the number of modules that are moved to obtain the improvement. That is, a ratio of gain to cost may be determined. A high ratio may result from obtaining the highest gain (i.e. improvement in balance) at the smallest cost (i.e. fewest module moves).

Other approaches may also be utilized to find the optimum algorithm. According to an exemplary embodiment, the objective may be to achieve the highest gain regardless of the number of moves involved in obtaining this gain. According to another exemplary embodiment, the objective may be to obtain the highest gain for a given maximum number of moves. According to a further exemplary embodiment, the objective may be to minimize the load on the processor with the highest load. According to yet another exemplary embodiment, the objective may be to maximize the load on the processor with the lowest load.

According to yet a further exemplary approach, the objective may be to evaluate the difference between the load on the processor with highest load and the processor with the lowest load. In a multi core system, it may be preferable to have one core at a high (load) value and the remaining cores having loads that are as distributed as possible. This will, for example, minimize power consumption in multi-core processors.

Exemplary embodiments as described above may also be utilized for distributing files or content between nodes/discs/servers, etc. For example, a content provider hosts or includes a number of files such as web pages, music pieces, movies, etc. Content may be stored on multiple servers. Each particular file or piece of content X may attract an interest that may be represented by Y=Y(X). The interest may correspond to or generate traffic represented by Z=Z(Y) for example. The total traffic to each node/disc thus depends on the popularity of all its particular objects. The objects may be distributed over different nodes/discs. Then, it would be preferable to make the distribution such that the traffic to the different nodes/discs is balanced. Files and content may be balanced in a manner similar to balancing programs or program modules. The nodes/discs may be treated as processing resources/elements, etc. while the traffic or interest for particular content may be treated as the load (programs, etc.).

While a certain amount of computing may be required to perform a dry run resulting in an introduction of delay, such delay is of little significance.

If, under some circumstances, processing and delay become a problem, certain algorithms can be excluded from some or all dry runs. The choices of algorithms to exclude and when to exclude them can be based on observation and past history and/or experience.

Strategies for selection of algorithms may include eliminating execution of algorithms that rarely, if ever, provide an optimal balancing result. Some algorithms may provide an optimal balancing result under very special circumstances and these algorithms may be excluded from execution when such circumstances are not present and thus temporarily excluding these algorithms from irrelevant runs.

The choice of excluding or including algorithms can be manual (set by direct commands), rule based (set according to rules which in turn are set by commands) or automatic (set by a self-learning system the optimization criterion of which may be set by commands).

It will also be appreciated that procedures described above may be carried out repetitively as necessary. To facilitate understanding, aspects of the invention are described in terms of sequences of actions that can be performed by, for example, elements of a programmable computer system. It will be recognized that various actions could be performed by specialized circuits, by program instructions executed by one or more processors, or by a combination of both.

It is emphasized that the terms “comprises” and “comprising”, when used in this application, specify the presence of stated features, integers, steps, or components and do not preclude the presence or addition of one or more other features, integers, steps, components, or groups thereof.

Thus, this invention may be embodied in many different forms, not all of which are described above, and all such forms are contemplated to be within the scope of the invention. The particular embodiments described above are merely illustrative and should not be considered restrictive in any way. The scope of the invention is determined by the following claims, and all variations and equivalents that fall within the range of the claims are intended to be embraced therein.

1. A method of balancing loads in a system having a plurality of processing elements, the method comprising:
executing a plurality of load balancing algorithms in a dry run on load data from the system;
recording results of each of the load balancing algorithms;
evaluating the results of each of the load balancing algorithms;
selecting the load balancing algorithm providing the best results; and
implementing the results of the selected algorithm on the system,
wherein the plurality of load balancing algorithms are each a set of different rules for solving a problem in a finite number of steps.

2. The method of claim 1, wherein the evaluating comprises computing a difference between the monitored load of the processing element having the highest load in the system and the calculated load of the processing element having the highest load in the dry run and dividing the difference by the number of moves of load data among the plurality of processing elements needed to obtain the difference.

3. The method of claim 1, wherein the algorithms are executed at a periodic interval.

4. (canceled)

5. The method of claim 1, wherein a gain from implementing the results in the system is measured by a reduction of load on the most loaded processing element and the cost is measured by a number of moves of load data among the plurality of processing elements needed to obtain the reduction.

6. The method of claim 1, wherein in selecting the load balancing algorithm providing the best results, a gain from implementing the results in the system represented by a reduction of load on the highest loaded processing element is one of a plurality of determining factors in selecting the load balancing algorithm.

7. The method of claim 6, wherein the implemented results provide the gain for a specified number of moves of load data among the plurality of processing elements.

8. The method of claim 1, wherein in selecting the load balancing algorithm providing the best results, the implemented results that minimize the load on the processing element having the highest load is one of a plurality of determining factors in selecting the load balancing algorithm.

9. The method of claim 1, wherein in selecting the load balancing algorithm providing the best results, the implemented results that maximize the load on the processing element having the lowest load is one of a plurality of determining factors in selecting the load balancing algorithm.

10. The method of claim 1, wherein the evaluating comprises computing the difference between the load on the processing element having the highest load and the processing element having the lowest load.

11. (canceled)

12. The method of claim 11, wherein in selecting the load balancing algorithm providing the best results, algorithms that have a low rate of success in balancing loads are excluded from execution, and wherein algorithms that have a low rate of success are algorithms that are not able to balance the load among the plurality of processing elements as well as others among the plurality of load balancing algorithms.

13. (canceled)

14. (Originally Filed) The method of claim 11, wherein the choice is rule based, the rules being set by commands.

15. The method of claim 11, wherein the choice is made on an automatic basis by a self-learning system.

16. The method of claim 1, wherein the processing elements are in a virtual machine.

17. The method of claim 1, wherein the processing elements form a cluster interconnect.

18. The method of claim 1, wherein the loads that are balanced are caused by programs.

19. (canceled)

20. The method of claim 1, wherein the loads that are balanced are caused by virtual machines.

21. The method of claim 1, wherein the results of a selected algorithm is a placement list.

22. The method of claim 1, wherein the processing elements are servers containing content and the loads correspond to traffic interest in content on the servers.

23. (canceled)

24. The method of claim 1, wherein the plurality of load balancing algorithms comprise a distribution algorithm, a move big job algorithm, a greedy moves algorithm, a partitioning algorithm, and a hybrid algorithm comprising one or more of the distribution, move big job, greedy moves and partitioning algorithms.

25. The method of claim 2, wherein the load data is software, programs, processes, virtual machines or data that places a load on one or more of the plurality of processing elements.
